(19) United States
(12) Patent Application Publication
(10) Pub. No.: US 2006/0221502 A1
(43) Pub. Date: Oct. 5, 2006

(54) Magnetic head and manufacturing method of the same

(75) Inventors: Jun Watanabe, Kawasaki (JP); Yoshiharu Kasamatsu, Kawasaki (JP); Takayuki Musashi, Kawasaki (JP); Hiroshi Chiba, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/158,050

(22) Filed: Jun. 22, 2005

(30) Foreign Application Priority Data
Mar. 31, 2005 (JP) 2005-105238

(51) Int. Cl. G11B 5/60

(52) U.S. Cl. 360/235.8; 360/236.3; 360/236.2

(57) ABSTRACT

A magnetic head includes a head slider configured to float above a recording medium and having an element part for recording to and reproducing from the recording medium, the element part being situated on a medium facing surface facing to the recording medium. The medium facing surface has a first air bearing surface situated in a vicinity of a side of an air flow-out end. The medium facing surface has a rear rail having the element part situated at the side of the air flow-out end of the first air bearing surface. The first air bearing surface is covered with a lubricating layer made of water repellent resin and has an average surface roughness larger than an average surface roughness of a surface of the element part.

### BACKGROUND OF THE INVENTION

1. Field of the Invention

The present invention generally relates to magnetic heads and manufacturing methods of the same, and more specifically, to a magnetic head having good floating stability in a case of a low floating amount and a manufacturing method of the same.

2. Description of the Related Art

In a magnetic storage apparatus having a magnetic disk, a magnetic head records information on the magnetic disk or reproduces information recorded on the magnetic disk while a constant distance between the magnetic disk and the magnetic head is kept. Recently and continuing, accompanying improvement in recording density of the magnetic disk, the distance between the magnetic head and the magnetic disk, that is a floating amount, is being reduced. This is because the information recorded on the magnetic disk is made minute and therefore it is necessary to make the magnetic head come close to the magnetic disk and apply a recording magnetic field to a minute area or detect a magnetic field emanating from the magnetic disk to a minute space.

Accompanying the high recoding density of the magnetic storage apparatus, the floating amount of the magnetic head is reduced to be approximately ten and several nm and therefore a floating property may be unstable for various reasons. Furthermore, an error occurs due to unstableness of a recording reproducing property and a head crash may be generated due to contact between the head slider of the magnetic head and the magnetic disk. Volatile organic matter or dust inside the magnetic storage apparatus is adsorbed to the medium facing surface of the head slider or a surface of the magnetic disk so that the floating property is made unstable. Due to such an adsorbed particle, the medium facing surface of the head slider and the magnetic disk may become adsorbed. In addition, an adsorption force working on the medium facing surface and the magnetic disk when water goes in between the medium facing surface and the magnetic disk is increased so that rotation of the magnetic disk is stopped or does not start.

In order to solve such a problem, a magnetic apparatus is proposed wherein a lubricating layer is formed on the medium facing surface of the head slider so that the medium facing surface may not be wet by water and adhesion of the head slider and made disk due to water is prevented. See Japan Patent Application Publication No. 5-325161.

Meanwhile, as the distance between the medium facing surface of the head slider and the magnetic disk surface is shortened, Van der Waals force works between the medium facing surface and the magnetic disk as an attraction force having an un-ignorable large amount, so that a bad influence is given to the floating stability. If an area of a rear rail is reduced to reduce the Van der Waals force, the floating amount is reduced so that it is difficult to make a floating design and the volatile organic matter or the dust inside of the magnetic storage apparatus is further adsorbed to the medium facing surface of the head slider or the surface of the magnetic disk so that the floating property is made further unstable.

In a case where the lubricating layer is simply formed on the medium facing surface in the magnetic head whose floating amount is extremely small as shown in Japan Patent Application Publication No. 5-325161, the Van der Waals force cannot be ignored and the floating stability may not be sufficient. In addition, in a case where the head slider accidentally comes in contact with the magnetic disk surface while the magnetic head floats, the head slider and the magnetic disk may be adhered to each other.

### SUMMARY OF THE INVENTION

Accordingly, it is a general object of the present invention to provide a novel and useful magnetic head and manufacturing method of the same.

Another and more specific object of the present invention is to provide a magnetic head having good floating stability and a manufacturing method of the same.

The above object of the present invention is achieved by a magnetic head, including:

a head slider configured to float above a recording medium and having an element part for recording to and reproducing from the recording medium, the element part being situated on a medium facing surface facing to the recording medium;

wherein the medium facing surface has a first air bearing surface situated in a vicinity of a side of an air flow-out end,

the medium facing surface has a rear rail having the element part situated at the side of the air flow-out end of the first air bearing surface, and

the first air bearing surface is covered with a lubricating layer made of water repellent resin and has an average surface roughness larger than an average surface roughness of a surface of the element part.

According to the present invention, the lubricating layer made of the water repellent resin is formed on the first air bearing surface of the rear rail formed at the side of the air flow-out end of the head slider of the magnetic head. Since such a lubricating layer has low surface free energy, it is difficult for water or dust to be adsorbed by the lubricating layer.

In addition, since the first air bearing surface has the average surface roughness larger than an average surface roughness of the surface of the element part, it is possible to reduce the Van der Waals force with the recording medium surface. In addition, since the first air bearing surface has a large average surface roughness, the surface free energy of the first air bearing surface is low. Therefore, the surface free energy and the Van der Waals force of the first air bearing surface can be reduced due to the lubricating layer and a rough surface. As a result of this, even if the first air bearing surface and the recording medium come too close at the time of floating, the attraction force working between the first air bearing surface and the recording medium can be reduced so that adhesion can be prevented. Hence, it is possible to realize a magnetic head having good floating stability.

The medium facing surface may further include an adsorption prevention pad configured to prevent adhesion with the recording medium, and a surface of the adsorption prevention pad may be covered with the lubricating layer.

Since the adsorption prevention pad comes close to the recording medium surface at the time of floating of the head slider, the lubricating layer is formed on the surface of the adsorption prevention pad and the magnetic head having good floating stability can be realized by making the average surface roughness large.

The average surface roughness of the first air bearing surface may be equal to or larger than 0.4 nm and equal to or smaller than 3.0 nm.

The average surface roughness of the air bearing surface of the conventional magnetic head is approximately 0.2 nm. The first air bearing surface of the present invention is set to be rougher than the conventional air bearing surface. The above-mentioned range is obtained by the following embodiment. If the average surface roughness is smaller than 0.4 nm, the attraction force working between the air bearing surface and the recording medium is dramatically increased. If the average surface roughness is larger than 3.0 nm, the probability of contact with the recording medium at the time of floating is increased.

The above-object of the present invention is achieved by a manufacturing method of a magnetic head, the magnetic head having a head slider configured to float above a recording medium and having an element part for recording to and reproducing information from the recording medium, the element part being situated on a medium facing surface facing the recording medium, the manufacturing method including the steps of:

a) forming the medium facing surface by processing a designated surface of a base part where the element part is formed; and

b) forming a lubricating layer on the medium facing surface;

wherein the step a) includes a process of surface-roughening an area functioning as an air bearing surface, and

the lubricating layer covering at least the area which is a surface-roughened air bearing surface is formed in the step b).

According to this invention, in this manufacturing method, the lubricating layer is formed after the medium facing surface is formed. Hence, it is possible to avoid giving the bad influence to the lubricating layer at the time of processing the medium facing surface such as a reactive ion etching processing or elimination of a photo resist film, and thereby the generation of unevenness of the film thickness of the lubricating layer and degradation of the lubricating layer can be prevented. Therefore, a uniform lubricating layer having a high quality can be formed on a rough air bearing surface, so that a magnetic head having good floating stability can be formed.

Other objects, features, and advantages of the present invention will be come more apparent from the following detailed description when read in conjunction with the accompanying drawings.

### BRIEF DESCRIPTION OF THE DRAWINGS

FIG. 1 is a plan view showing a main part of a magnetic storage apparatus of the embodiment of the present invention;

FIG. 2 is a plan view seen from a side of a medium facing surface of a magnetic head of the embodiment of the present invention;

FIG. 3 is a schematic view showing a state where the magnetic head floats above a magnetic disk;

FIG. 4 is a perspective view of a head slider;

FIG. 5 is a plan view showing a medium facing surface of the head slider shown in FIG. 4;

FIG. 6-(A) is a cross-sectional view taken along the line X-X of FIG. 5 and FIG. 6-(B) is an enlarged view of part A in FIG. 6-(A);

FIG. 7 is a flowchart showing a manufacturing process of the magnetic head of the embodiment of the present invention;

FIG. 8 is a first schematic view showing a part of the manufacturing process of the magnetic head of the embodiment of the present invention;

FIG. 9-(A) through FIG. 9-(D) is a second schematic view showing a part of the manufacturing process of the magnetic head of the embodiment of the present invention;

FIG. 10-(A) is a perspective view of another example of the head slider and FIG. 10-(B) is an enlarged cross-sectional view of a C part in FIG. 10-(A);

FIG. 11 is a graph showing a relationship between a coefficient of friction and an average surface roughness of an air bearing surface of the embodiment;

FIG. 12 is a graph showing a relationship between a take-off height and a thickness of a lubricating layer in the embodiment; and

FIG. 13 is a graph showing a relationship between a touch-down pressure and the thickness of a lubricating layer in the embodiment.

### DETAILED DESCRIPTION OF THE PREFERRED EMBODIMENTS

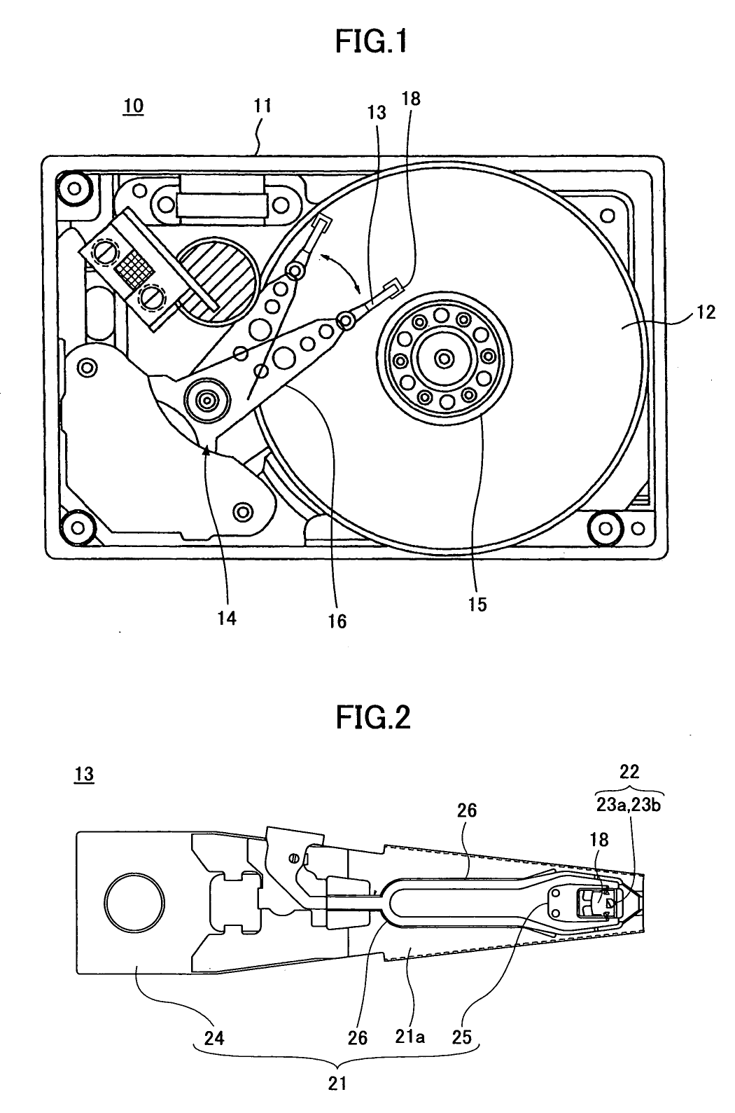

A description is given below, with reference to the FIG. 1 through FIG. 13 of embodiments of the present invention.

FIG. 1 is a plan view showing a main part of a magnetic storage apparatus of the embodiment of the present invention.

Referring to FIG. 1, a magnetic storage apparatus 10 has a structure where a magnetic disk 12, a magnetic head 13, an actuator unit 14, or the like are stored in a housing 11. The magnetic disk 12 fixed to a hub 15 is driven by a spindle motor (not shown). A base part of the magnetic head 13 is fixed to an arm 16 so that the magnetic head 13 is installed in the actuator unit 14 via the arm 16. The magnetic head 13 is rotated in a direction of the diameter of the magnetic disk 12 by the actuator unit 14. An electronic substrate (not shown) provided at a back side of the housing 11 performs recording reproduction control, magnetic head position control, spindle motor control, and others.

An in-plane magnetic recording medium, a vertical magnetic recording medium or an optical magnetic disk may be used as the magnetic disk 12. Information can be recorded on or reproduced from the magnetic disk 12 by the magnetic head 13.

The in-plane magnetic recording medium includes a recording layer which magnetizes in a direction parallel with a substrate surface of the magnetic disk 12. The recording layer is not limited to a single ferromagnetic layer but may be a laminated body formed by plural ferromagnetic layers. In addition, the recording layer may have a laminated ferromagnetic structure wherein a non-magnetic layer is put between lower and upper part magnetic layers so that magnetizations of the lower and upper part magnetic layers are arranged in anti-parallel in a state where a recording magnetic field is not applied. A Cr film or a Cr alloy film (W, Mo, V, B, or the like is used as an additional element) is used as a primary layer (foundation) of the recording layer.

The vertical recording medium includes a vertical magnetization film having magnetization in a direction perpendicular to the substrate surface of the magnetic disk 12 and a soft magnetic back layer situated on a substrate side of the vertical magnetization film.

The recording layers of the in-plane magnetic recording medium and vertical magnetic recording medium are formed by a material selected from a group consisting of Ni, Fe, Co, Ni group alloy, Fe group alloy, Co group alloy including CoCrTa, CoCrPt, and CoCrPt-M. Here, M is selected from B, Mo, Nb, Ta, W, Cu and their alloys. The thickness of the recording layer is set in a range from 3 nm through 30 nm.

A head slider 18 is provided at a head end of the magnetic head 13. Details of the magnetic head 13 and the head slider 18 are as follows.

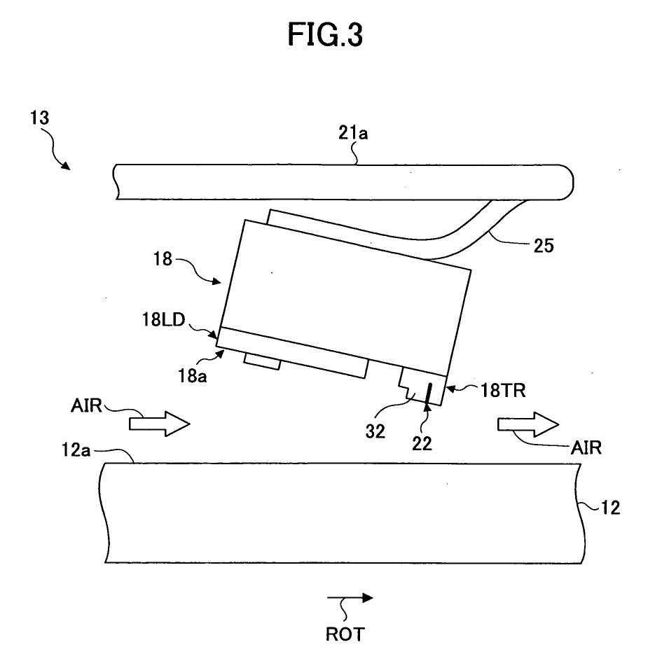

FIG. 2 is a plan view seen from a side of a medium facing surface of a magnetic head of the embodiment of the present invention. FIG. 3 is a schematic view showing a state where the magnetic head 13 floats above a magnetic disk 12.

Referring to FIG. 2 and FIG. 3, the magnetic head 13 includes a suspension 21, the head slider 18 fixed to the head end part of the magnetic head 13, an element part 22 formed in the head slider 18 and recording or reproducing (more specifically a recording element 23a and a reproducing element 23b. They are not shown since they are micro-sized), and others.

The suspension 21 includes a suspension main body part 21a, a base plate 24, a gimbal 25, a wiring pattern 26, or the like. The suspension main body part 21a is made of a plate-shaped metal material. The base plate 24 is provided at a base part of the suspension main body part 21a. The gimbal 25 is provided at a head end part of the suspension main body part 21a so as to fix the head slider 18. The wiring pattern 26 electrically connects the recording and reproducing elements 23a and 23b and a head IC (not shown). The base plate 24 is fixed to the arm 16 of the actuator unit 14 shown in FIG. 1 by fitting, for example. The suspension main body part 21a is made of a metal material such as a stainless material having a plate thickness of 100 μm and functions as a plate spring.

As shown in FIG. 3, the head slider 18 of the magnetic head 13 floats above the magnetic disk 12 moving in the direction of an arrow ROT. The medium facing surface 18a of the head slider 18 receives pressure due to an air flow AIR flowing based on movement of the magnetic disk 12. Positive pressure (floating force, that is, pressure whereby the head slider 18 floats) or negative pressure (pushing force, that is, a pressure whereby the head slider 18 is pushed to a side of the magnetic disk 12) is generated due to an irregularity of the surface of the medium facing surface. The head slider 18 receives a pushing force from the suspension main body 21a to a side of the magnetic disk 12 via the gimbal 25. Due to such floating and pushing forces, the head slider 18 floats in a state where the side of an air flow-in end 18LD is higher above the magnetic disk surface 12a than the side of an air flow-out end 18TR. That is, the side of the air flow-out end 18TR of the medium facing surface 18a of the head slider 18 comes closer to the magnetic disk surface 12a. An angle formed by the magnetic disk surface 12a and the medium facing surface 18a is set to be 200 μrad, for example.

A rear center rail 32 is formed at a side of the air flow-out end 18TR of the medium facing surface 18a. The element part 22 is formed in the rear center rail 32. The rear center rail 32 on the medium facing surface 18 has the shortest distance from the magnetic disk surface 12a. The magnetic head can obtain a stable recording and reproducing property by stably maintaining this distance, namely the floating amount, at the time of floating.

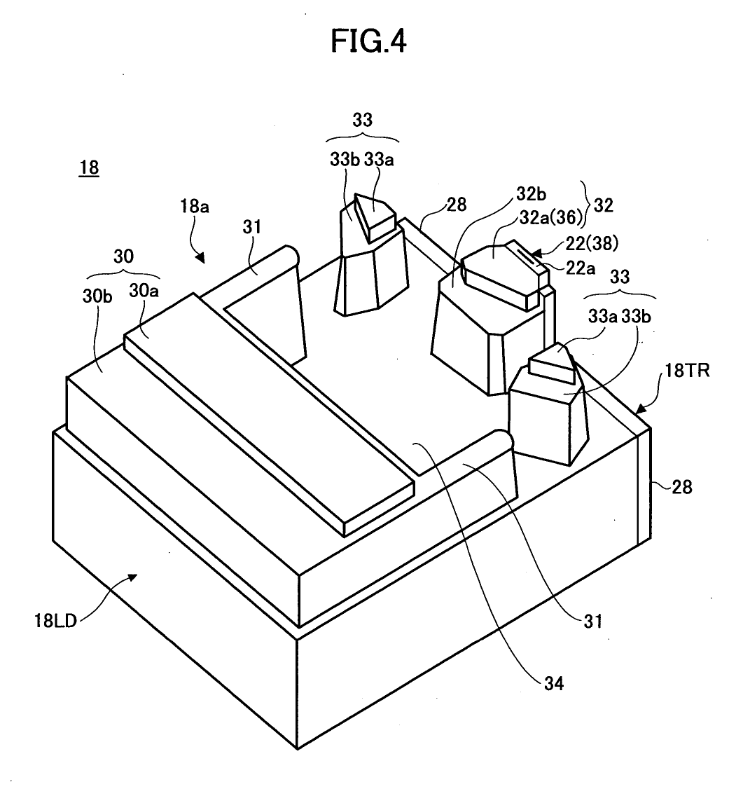

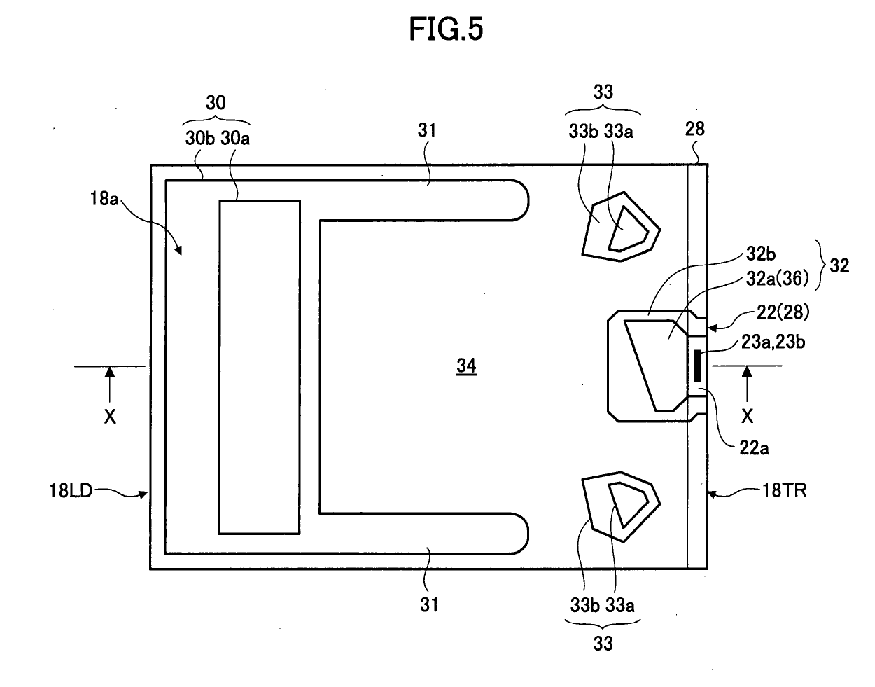

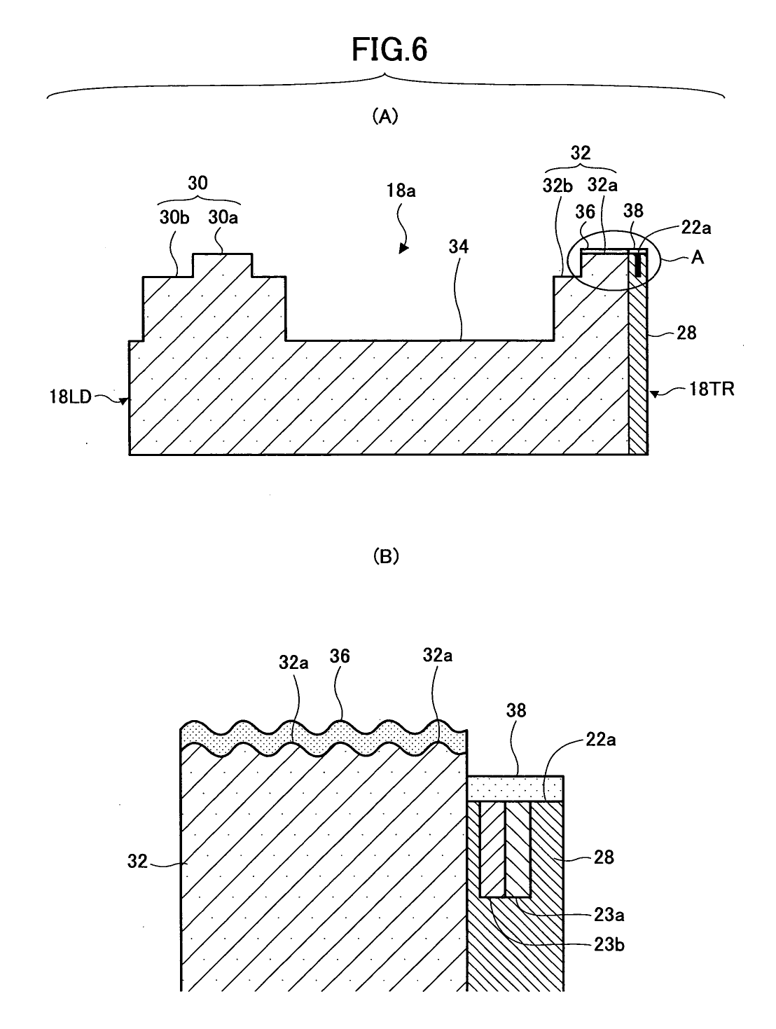

FIG. 4 is a perspective view of the head slider. FIG. 5 is a plan view showing the medium facing surface of the head slider shown in FIG. 4. FIG. 6-(A) is a cross-sectional view taken along the line X-X of FIG. 5 and FIG. 6-(B) is an enlarged view of part A in FIG. 6-(A).

Referring to FIG. 4 through FIG. 6, the head slider 18 having a substantial rectangular parallelepiped configuration has a size of 1.25 mm (length), 1.0 mm (width), and 0.30 mm (height) and is made of a ceramic material such as Al₂O₃ TiC. A protection film such as an aluminum film having a thickness of several tens μm is formed at the side of the air flow-out end 18TR of the head slider 18. A protection film such as diamond-like-carbon may be formed on a ceramic material in the medium facing surface 18a.

A front rail 30 is formed at a side of the air flow-in end 18LD of the medium facing surface 18a. A side rail 31 extending toward the side of the air flow-out end 18TR is formed at each side of the front rail 30. A rear center rail 32 is formed in a substantially center part in a head slider width direction at the side of the air flow-out end 18TR of the medium facing surface 18a, and a rear side rail 33 is formed at each side of the rear center rail 32.

The front rail 30 has a step-shaped configuration and has an air bearing surface 30a extending to the side and a step surface 30b. The step surface 30b is situated lower than the air bearing surface 30a. The step surface 30b surrounds the air bearing surface 30a. The side rails 31 are formed so as to have the same height as the step surface 30b.

A groove forming part 34 is formed at the side of the air flow-out end 18TR of the front rail 30. The grove forming part 34 has a depth of approximately 2 through 3 μm from the air bearing surface 30a, for example.

The rear center rail 32, formed in a substantially center part in a head slider width direction at the side of the air flow-out end 18TR, has a step-shaped configuration and has an air bearing surface 32a and a step surface 32b. The step surface 32b is situated lower than the air bearing surface 32a. The step surface 32b is situated at the side of the air flow-in end 18LD of the air bearing surface 32a.

The element part 22 is formed at a side of the air flow-out end 18TR of the air bearing surface 32a of the rear center rail 32. In the element part 22, as shown in FIG. 6-(B), the reproducing element 23b and the recording element 23a are laminated from a side of the rear center rail 32 in this order. As the reproducing element 23b, it is possible to use, for example, a Spin Valve Magneto-Resistance (MR) effect element, a Ferromagnetic Tunnel Junction MR (TMR) element, a Ballistic MR element, or the like. As the recording element 23a, it is possible to use, for example, a thin film inducing-type recording element (ring-type head or a single magnetic pole for a vertical magnetic recording medium.

The rear side rail 33 has a step-shaped configuration and has an air bearing surface 33a and a step surface 33b. The step surface 33b is situated lower than the air bearing surface 33a.

The air bearing surfaces 30a, 32a and 33a are situated highest on the medium facing surface 18a. The configurations and measurements of the air bearing surfaces 30a, 32a and 33a are properly set by a parameter of the floating design such as a floating amount or floating position (pitch angle, roll angle, or the like).

As shown in FIG. 6-(B), the surface roughness pf the air bearing surface 32a of the rear center rail 32 is set to be rougher than the element part surface 22a. That is, the element part surface 22a is set to be approximately the same as the roughness made by conventional finish polishing. On the other hand, the air bearing surface 32a is set to be rougher than the roughness made by the conventional finish polishing. By making the air bearing surface 32a roughened, the increasing of the Van der Waals force (attraction force) working between the air bearing surface 32a and the magnetic disk surface at the time of floating can be prevented even if the amount of floating is extremely low, equal to or less than 10 nm. As a result of this, it is possible to avoid the adhesion of the head slider 18 to the magnetic disk surface.

Conventionally, the average surface roughness of the air bearing surface 32a and the element part surface 22a of the conventional magnetic head are the same and approximately 0.2 nm. On the other hand, in this embodiment, it is preferable that the average surface roughness of the air bearing surface 32a be set equal to or larger than 0.4 nm and equal to or smaller than 3.0 nm. In a case where the average surface roughness is larger than 3.0 nm, it may be easy for a minute projection part situated on the air bearing surface 32a to come in contact with the magnetic disk surface. In a case where the average surface roughness is smaller than 0.4 nm, when the air bearing surface 32a comes in contact with the magnetic disk surface, the attraction force increases so that it may be easy for the air bearing surface 32a and the magnetic disk surface to be adhered to each other. The surface roughness is measured in the range of a rectangle of 10 μm×10 μm by using an atomic force microscope (AFM) and a contact having a head whose radius of curvature is 20 nm.

The change of the floating amount may be reduced in a micro floating state wherein the floating amount is equal to or smaller than 10 nm, by surface roughening the air bearing surface 32a like this. That is, in a case where the air bearing surface 32a is surface-roughened, venting of an air flow passing through a micro gap between the air bearing surface 32a and the magnetic disk surface is smoothened in a level of molecular forming air.

The micro configuration of the air bearing surface 32a is not limited but may be a configuration where grooves like polishing traces are formed lengthwise and crosswise or a configuration formed by rounded micro mountains and valleys.

Such a surface-roughening may be implemented in the air bearing surface 33a of the rear side rail 33 or the air bearing surface 30a of the front rail 30 as well as the air bearing surface 32a of the center rail 32. That is, the average surface roughness of the air bearing surface 33a or 30a is set to be rougher than the average surface roughness of the element part surface 22a. Under this setting, the Van der Waals force working between the air bearing surfaces 33a and 30a and the magnetic disk surface can be controlled. As a result of this, it is possible to further prevent the adhesion between the head slider 18 and the magnetic disk surface.

Depending on a position in a radius direction of the magnetic head, the distance between the air bearing surface 33a of the rear side rail 33 and the magnetic disk surface may be shorter than the distance between the rear center rail 32 and the magnetic surface. In this case, the surface-roughening of the air bearing surface 33a is especially effective. It is preferable that the average surface roughness of the air bearing surface 33a be set to the same range as the average surface roughness of the air bearing surface 32a of the rear center rail 32.

In addition, it is preferable that the average surface roughness of the air bearing surface 32a of the rear center rail 32 be larger than the average surface roughness of the air bearing surface 33a of the rear side rail 33 or the air bearing surface 30a of the front rail 30.

Furthermore, as shown in FIG. 6-(B), lubricating layers 36 and 38 made of the water repellent resin are formed on the air bearing surface 32a of the rear center rail 32 and the surface 22a of the element part, respectively. It is made difficult for volatile organic matter or dust to be adsorbed on the surfaces of the air bearing surface 32a and the surface 22a of the element part by covering the air bearing surface 32a and the surface 22a of the element part with the lubricating layers 36 and 38. The attraction force between the magnetic disk 12 and the air bearing surface 32a of the rear center rail 32 or the surface 22a of the element part 22 is reduced by the lubricating layers 36 and 38, even if the air bearing surface 32a or the surface 22a comes in contact with the magnetic disk 12, so that it is difficult for the head slider 18 to be peeled off from the magnetic disk.

It is preferable that the lubricating layers 36 and 38 made of the water repellent resin be “substantially chemically bonded” (chemical adsorption layer) to the air bearing surface 32a or the surface 22a. “Substantially chemically bonded” does not require confirming if the chemical bonding is actually generated. It is sufficient for a lubricating layer which is physically adsorbed, namely a physical adsorption layer, to be equal to or less than several weight percents against the entire lubricating layers 36 and 38. The physical adsorption layer can be easily separated by cleaning using a solvent. In a case where the lubricating layer is adsorbed to the air bearing surface 32a and the element part surface 22a by using a weak adsorption force such as physical adsorption, the lubricating layer may be an obstacle for floating. However, in a case where the lubricating layers 36 and 38 are substantially chemically bonded to the air bearing surface 32a or the surface 22a, it is possible to make lubricating layers 36 and 38 which are stable and do not easily scatter.

It is preferable that the thickness of the lubricating layers 36 and 38 be set equal to or larger than 0.5 nm, and be set equal to or smaller than 2.0 nm. If the thickness of the lubricating layers 36 and 38 is larger than 2.0 nm, a distance between the medium facing surface 18a and the magnetic disk 12 is increased so that a reproduction output or S/N ratio may be decreased. If the thickness of the lubricating layers 36 and 38 is smaller than 0.5 nm, it may be difficult to uniformly cover the entirety of the medium facing surface 18a.

Although any material can be used for the lubricating layer 36 or 38 without departing from the scope of the present invention, it is preferable to include a fluoride group lubricating agent in the lubricating layer 36 or 38. As the fluoride group lubricating agent, fluorine group carbon hydride, fluorine group polyether, or the mixture of them can be used. Particularly, perfluoro carbon hydride, perfluoro polyether, or a mixture of them is preferable to be used as the fluoride group lubricating agent. The fluorine group carbon hydride, perfluoro carbon hydride, fluorine group polyether, and perfluoro polyether may be straight-chain molecule or bifurcated molecules.

In addition, as a terminal group of the lubricating agent molecule of the lubricating agent forming the lubricating layer 36 or 38, a polar group such as CF₂CHOH, C₆H₅, piperonyl group or a no-polar group such as trifluoromethyl group may be used.

As fluorine content in a single molecule of the lubricating agent of the lubricating layer 36 or 38 is larger, a condense is smaller so that it is possible to uniformly form a layer and surface tension can be small. It is preferable that the fluorine content be equal to or more than 80%, more preferable that the fluorine content be equal to or more than 90%, and most preferable that the fluorine content be equal to or more than 95%. It is also preferable that the weight average molecular amount of the lubricating agents of the lubricating layers 36 and 38 be set in a range from 2000 through 20000. Here, the fluoride content is the ratio of the molecular amount of fluoride included in a single molecule against the molecular amount of the lubricating agent molecule in a single molecule.

The chemical adsorption layer is formed in a case where the lubricating agent molecule having the polar group as the terminal group is chemically bonded to the medium facing surface or a case where the lubricating agent having the non-polar group or the polar group as the terminal group is chemically bonded to the medium facing surface by irradiation of a high energy beam or ray or a heating process. Since the chemical adsorption layer is strongly bonded to the medium facing surface, it may be difficult for the chemical adsorption layer to move the magnetic disk at the time of floating, loading or unloading the magnetic head.

It is also preferable that fixing ratios of the lubricating layers 36 and 38 be set to be equal to or more than 30% or equal to or less than 100%. In a case where the fixing ratio is smaller than 30%, if a running test for floating the magnetic head above the magnetic disk is implemented under a severe environment of high temperature and high humidity (for example, 80° C. 60% RH), a head crash may be easily generated. It is also preferable that the fixing ratio be equal to or more than 70% and equal to or less than 100%. In order to form a lubricating layer having such a fixing ratio, as described below, the applied lubricating agent is immersion-eliminated by the agent and a high energy beam or ray is irradiated.

The lubricating layer may be formed so as to cover the air bearing surface 30a of the front rail 30 or the air bearing surface 33a of the rear side rail 33 so that the surface free energies of these surfaces are reduced and adsorption of water or dust may be prevented. In addition, the lubricating layer may be formed so as to cover the entire surface of the medium facing surface 18a.

In the magnetic head 13 of this embodiment, a lubricating layer 36 made of the water-repellent resin is formed on the air bearing surface 32a of the rear center rail 32 formed at the side of the air flow-out end 18TR of the head slider 18. Since such a lubricating layer 36 has a low surface free energy, it may be difficult for water or the dust to adsorb. In addition, since the air bearing surface 32a has a surface rougher than the element part surface 22a, it is possible to reduce the Van der Waals force between the magnetic disk surface and the air bearing surface 32a. Furthermore, the surface free energy of the air bearing surface 32a is low. Therefore, by the lubricating layer 36 and a rough surface, the surface free energy of the air bearing surface 32a can be made low and the Van der Waals force can be reduced even if the air bearing surface 32a comes close to the magnetic disk surface. As a result of this, even if the air bearing surface 32a and the magnetic disk surface come too close at the time of floating, the attraction force working between the air bearing surface 32a and the magnetic disk is reduced so that the adhesion can be prevented. Since the lubricating layer 38 made of the water-repellent resin is formed on the element part surface 22a, the surface free energy of the element part surface 22a is low and therefore it is difficult for water or the dust to be adsorbed. Therefore, it is possible to realize the magnetic head having good floating-stability.

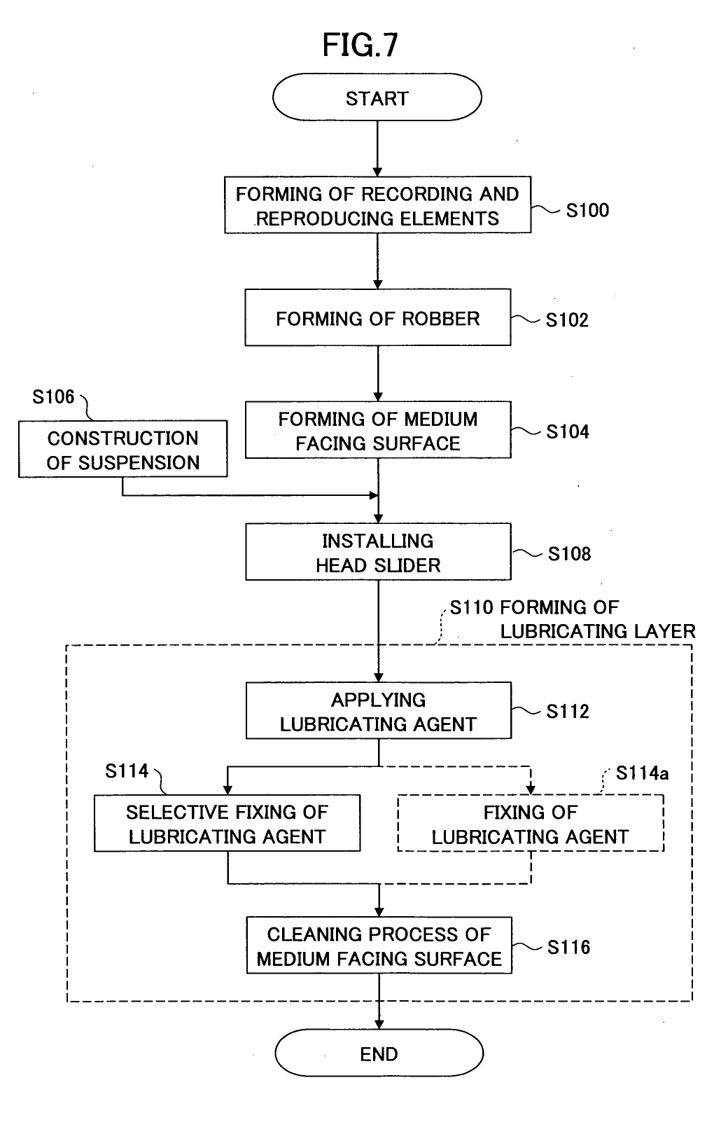

Next, a manufacturing method of the magnetic head of this embodiment is discussed with reference to FIG. 7 through FIG. 9.

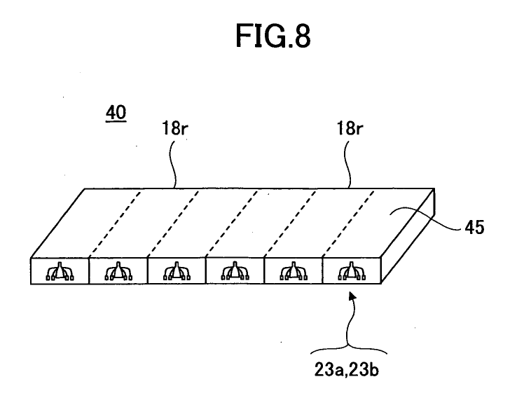

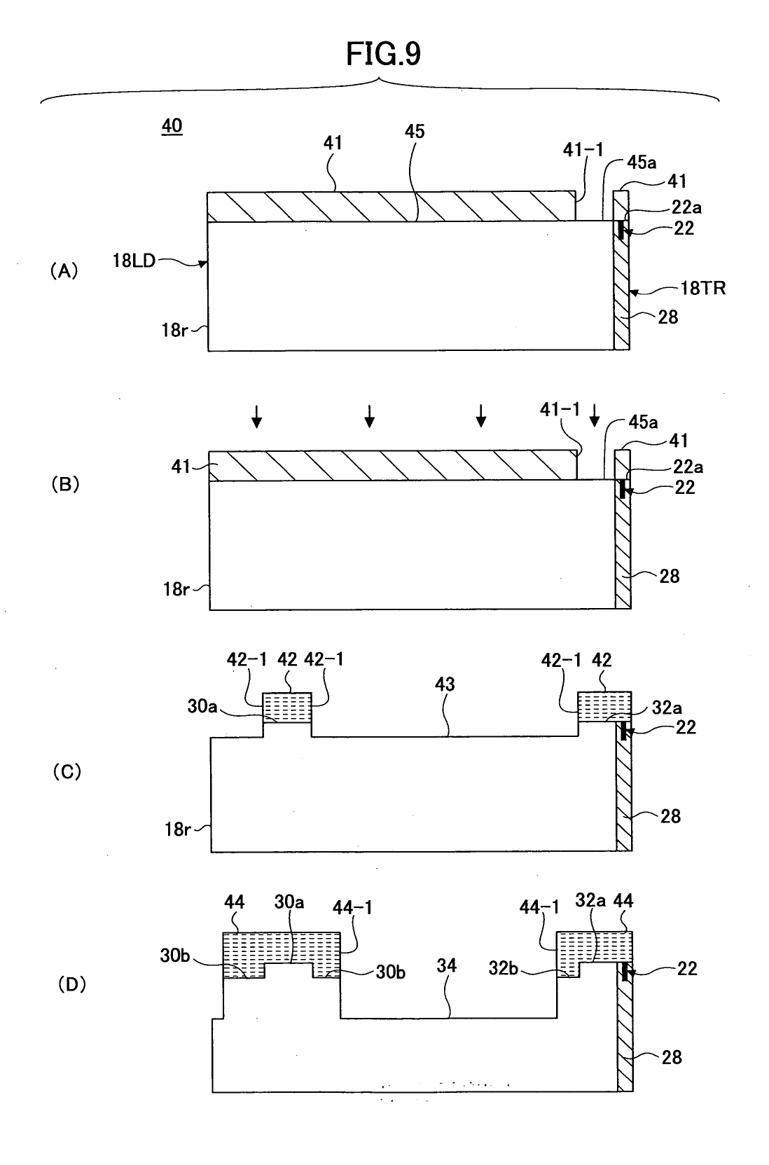

FIG. 7 is a flowchart showing a manufacturing process of the magnetic head of the embodiment of the present invention. FIG. 8 is a first schematic view showing a part of the manufacturing process of the magnetic head of the embodiment of the present invention. FIG. 9-(A) through FIG. 9-(D) is a second schematic view showing a part of the manufacturing process of the magnetic head of the embodiment of the present invention. More specifically, FIG. 8 is a perspective view of a robber 40. FIG. 9-(A) through FIG. 9-(D) shows a forming process of the medium facing surface.

First, a recording element and a reproducing element are laminated in turn on a wafer made of a ceramic material of Al₂O₃-TiC (S100). This step is implemented by a process the same as a semiconductor process so that element parts where the recording element and reproducing elements are laminated on a wafer are formed in a matrix shape.

Next, the wafer is cut with elements formed in a single line so that a robber 40 shown in FIG. 8 is formed. Blocks 18r functioning as head sliders respectively range in a width direction of the head slider so as to form the robber 40. One surface 45 of the robber 40 is a medium facing surface determined by the directions of the recording element 23a and reproducing element 23b. The other surface is fixed to the gimbal 25.

Next, the surface 45 of the robber 40 is processed so that the medium facing surface is formed (S104). This step is discussed with reference to FIG. 9-(A) through FIG. 9-(D). FIG. 9-(A) through FIG. 9-(D) is a cross-sectional view of the robber in directions the same as FIG. 6-(A).

In the process shown in FIG. 9-(A), the surface 45 which is a medium facing surface of the robber 40 is polished so as to be flattened. A process for flattening is implemented by a well-known polishing method such as mechanical polishing method or chemical mechanical polishing method. By this flattening process, the surface 45 has an average surface roughness of, for example, 0.2 nm.

In the process shown in FIG. 9-(A), a resist film 41 having an opening part 41-1 which exposes an area 45a being for a rear center rail 32 (See FIG. 6) is formed on the surface 45 by a photolithography method.

Then, in the process shown in FIG. 9-(B), a surface-roughening process for the area 45a is performed. More specifically, a reactive ion etching (RIE) method wherein CF₄ gas is used as etching gas is used for the surface-roughening process so as to obtain the average surface roughness of the area 45a of 0.4 nm through 3.0 nm. In a case where the CF₄ gas is used, since TiC forming a ceramic member of Al₂O₃-TiC is selectively etched, it is possible to easily surface-roughen. A surface roughness of a surface being the air bearing surface of the rear center rail is determined by this etching.

The etching may be performed by using a spatter etching method instead of the RIE method so that the area has a surface roughness having the same range as the above-discussed area. More specifically, a negative voltage is applied to the robber 40 by using the spatter etching device so as to form the bias electric field and accelerate and irradiate an Ar ion. In the spatter etching using the Ar ion, Al forming the ceramic member of Al₂O₃-TiC is easily etched, and it is possible to form a surface having a minute concave and convex configuration. An Xe ion or Kr ion may be used instead of the Ar ion. The etching may be performed by using both the etchings of the RIE method and the spatter etching method.

Although not shown in FIG. 9, a silicon nitride film or a silicon oxide film may be further formed and an opening part piercing the opening part 41-1 shown in FIG. 9-(B) is formed, so that that the surface being the air bearing surface may be surface-roughened by using an ion milling device.

Thus, the area 45a is surface-roughened by a surface-roughening process. Other air bearing surface such as an area being the air bearing surface 30a or 33a of the front rail 30 or rear side rail 33 shown in FIG. 4 may be surface-roughened simultaneously or in turn.

Next, in the process shown in FIG. 9-(C), the resist film 41 shown in FIG. 9-(B) is eliminated. Then, the area 45 shown in FIG. 9-(B) and the surface of the element part 22 are covered by the photolithography method so that the resist film 42 of a pattern having the opening part 42-1 exposing other areas is formed.

In the process shown in FIG. 9-(C), the etching is performed by the RIE method, for example, in a state where the resist film 42 is used as a mask, so that the step surface and the surface 43 being a top surface of the side rail are formed.

Next, in the process shown in FIG. 9-(D), the resist film 42 shown in FIG. 9-(C) is eliminated. Then, a resist film 44 is formed so as to cover the front rail 30, the rear center rail 32 and the rear side rails 33 shown in FIG. 4 and have an opening part 44-1 for exposing other area.

In the process shown in FIG. 9-(D), the etching is performed by the RIE method, for example, in a state where the resist film 44 is used as a mask, so that the groove forming part 34, the step surfaces 30b and 32b, and a step surface of the rear side rail (not shown) are formed.

After that, the resist film 44 shown in FIG. 9-(D) is eliminated so that the head slider 18 having a configuration of the medium facing surface 18a shown in FIG. 4 or the like is formed.

Referring back to FIG. 7, a construction of the suspension is performed (S106). More specifically, the suspension main body part 21a, the base plate 24, the gimbal 25, or the like are formed by a die punching process and the construction of these parts is performed. Then, the wiring pattern 26 formed separately is installed in the suspension main body part 21a.

Next, the head slider 18 is installed in the suspension (S108) so that a wiring pattern and an electrode (not shown) of the head slider 18 are electrically connected.

Then, the lubricating layer is formed on the medium facing surface of the head slider (S110). This forming process (S110) of the lubricating layer includes an application process of the lubricating solvent (S112), a selective fixing process of the lubricating process (S114), and a cleaning process of the medium facing surface (S116). A case where the lubricating layers 36 and 38 are formed on the air bearing surface 32a of the rear center rail 32 and the element part surface 22a, respectively, is discussed in the following.

First, the lubricating agent is applied to the medium facing surface (S112). A lubricating agent diluent solution is prepared and applied to the medium facing surface 18a by using a lifting method, spray method, liquid level depression method, or the like, so that the application process of the lubricating agent is achieved. The lubricating agent diluent solution is made by diluting the lubricating agent by using a diluent solvent such as Novec HEF (product name) manufactured by 3M or Vertrel (trademark) XF manufactured by Dupont.

It is preferable to use a lubricating agent whose terminal group is non-polar as the lubricating layer because the unnecessary lubricating layer can be easily removed in a cleaning process (S116) of the medium facing surface described later. In a case where the lubricating agent whose terminal group is non-polar is applied to the medium facing surface 18a, the lubricating layer is adsorbed to the medium facing surface 18a by physical adsorption.

A lubricating agent of molecules made of a main chain of perfluoropolyalkyl ether (PFPE) whose terminal group is non-polar, trifluoromethyl for example, is used in the application process of the lubricating agent. As such a lubricating agent, Fomblin (trademark) Z15, Z25, Y25, YR1800 (product name) manufactured by Solvay Solexis is used.

In a case where the lubricating agent is applied by the lifting method, the density of the lubricating agent diluent solution and a lifting speed are set so that the film thickness of the lubricating layer is in a range from 0.5 nm through 2.0 nm after the diluent solution is evaporated. The density of the lubricating agent of the lubricating agent diluent solution is set to be, for example, approximately 0.2 weight percent.

Next, a fixing process is selectively implemented for the obtained lubricating layer (S114). The selective fixing process of the lubricating layer is implemented by irradiation of the high energy beam or ray. Ultraviolet rays, X rays, an electronic beam, and a focused ion beam are used as the high energy ray or beam. The high energy beam or ray is irradiated on the air bearing surface 32a of the rear center rail 32 and the element part surface 22a and others are not irradiated. Under this structure, the lubricating layers 36 and 38 covering the air bearing surface 32a and the element part 22a are chemically bonded to the ground surfaces 32a and 22a, respectively. A lubricating layer (not shown) covering the medium facing surface 18a other than the air bearing surface 32a and the element part surface 22a is physically bonded to the ground surface at this time.

In the ultraviolet irradiation process, an ultraviolet ray having a high illuminance is irradiated by using a mercury lamp or excimer vacuum ultraviolet lamp. At this time, an area other than the air bearing surface 32a and the element part surface 22a is shielded from the irradiation of the ultraviolet ray by using the mask. Based on the irradiation of the ultraviolet ray, the air bearing surface 32a and the element part surface 22a are activated and an adsorption site is formed in the molecules of the lubricating agent so that the chemical adsorption layer is formed. Since the excimer vacuum ultraviolet lamp, particularly a xenon excimer lamp, irradiates a high brightness vacuum ultraviolet ray having a wave length of 172 nm, it is possible to efficiently implement the fixing process. Since such a process prevents attenuation of the ultraviolet ray, it is necessary to implement this process in the vessel under vacuum.

In addition, in the irradiation process of an electron beam, an electron beam is irradiated from an electron gun so that an electron beam having, for example, a accelerating voltage of 10 kV is irradiated on the lubricating layer in the vessel under vacuum. At this time, the scanning of the electron beam is controlled so that the area other than the air bearing surface 32a and the element part surface 22a is not irradiated. The surface where the electron beam is irradiated is activated as well as where the ultraviolet ray is irradiated, so that the adsorption site of the molecule of the lubricating layer is formed and the chemical adsorption layer is formed. Instead of the electron beam, a laser light of an ultraviolet ray or an infrared ray, X ray or focused ion beam may be used for the irradiation process.

Next, the cleaning process of the medium facing surface is implemented (S116). In the cleaning process of the medium facing surface, the head slider of the magnetic head is dipped into the above-discussed diluent solvent and then taken out from the solvent so as to be dried by natural evaporation. By this process, the lubricating layers 36 and 38 covering the air bearing surface 32a and the element part surface 22a stay. In addition, the lubricating layer staying as a physical adsorption layer is eliminated and the lubricating layer of the area other than the air bearing surface 32a and the element part surface 22a is eliminated.

Thus, the air bearing surface 32a of the rear center rail 32 is surface-roughened and the lubricating layers 36 and 38 are formed on the air bearing surface 32a and the element part surface 22a.

In this manufacturing method, by surface-roughening the air bearing surface 32a of the rear center rail 32 and selectively providing the lubricating layers 36 and 38 on the air bearing surface 32a and the element part surface 22a, the surface free energy of the air bearing surface 32a coming closest to the magnetic disk surface at the time of floating is reduced and the attraction force working between the magnetic disk and the air bearing surface 32a is reduced. Therefore, it is possible to improve the floating stability.

In this manufacturing method, since the lubricating layers 36 and 38 are formed after the air bearing surface 32a is roughened, it is possible to avoid bad influence given to the lubricating layers 36 and 38 at the time of processing of the medium facing surface such as the reactive ion etching processing or elimination of the resist film. Hence, the generation of unevenness or degradation of the film thickness of the lubricating layers 36 and 38 can be prevented. Therefore, since the uniform lubricating layers 36 and 38 having good quality can be formed on the roughened air bearing surface 32a and the element part surface 22a, it is possible to form the magnetic head having a good floating stability.

Next, a modified example of the lubricating layer forming process (S110) in a case where the lubricating layer is formed on the entire surface of the medium facing surface 18a is discussed with reference to FIG. 6 and FIG. 7. Explanation of processes that are the same as the processes in the above-discussed lubricating later forming process is omitted.

In the lubricating agent application process (S112), the lubricating agent whose terminal group is polar may be used in addition to the lubricating agent whose terminal group is non-polar. The application process of the lubricating agent (S112) is implemented in a same way as the above-discussed S112.

Next, the fixing process (S114a) is performed on the obtained lubricating layer. The fixing process of the lubricating layer is performed on the entire surface of the medium facing surface 18a. Therefore, a selective irradiation such as a mask or scanning of the beam is not necessary for the irradiation process of the above-discussed high energy ray or beam. In addition, a heating process may be used for the fixing process.

In the heating process, the medium facing surface 18a where the lubricating layer is formed is heated so as to have a temperature in a range from 80° C. through 200° C. by using an oven or RTP furnace. By heating the lubricating layer, in a case of the lubricating agent of molecules whose terminal group is polar, the physical adsorption layer can be moved to the chemical adsorption layer so that the film thickness of the chemical adsorption layer can be increased. In a case where the lubricating agent of molecules whose terminal group is non-polar, the adsorption site is formed on the medium facing surface or the lubricating agent molecules, so that the lubricating agent molecule is strongly bonded to the medium facing surface 18a or the other lubricating agent molecules.

In a case where the solvent agent whose terminal group is polar is used, a chemical adsorption layer formed by chemically bonding and fixing the molecules of the lubricating agent to the medium facing surface is formed only by applying the lubricating agent. Hence, the fixing process (S114a) may be omitted. In a case where the fixing process (S114a) is omitted, the film thickness of the final lubricating layer is determined after the cleaning process (S116) of the medium facing surface. Hence, it is necessary to determine the conditions for the process of applying the lubricating agent by considering how much the film thickness is reduced by the cleaning process.

Next, the cleaning process of the medium facing surface is implemented (S116). This cleaning process is implemented in the same way as the above-mentioned process. The physical adsorption layer staying in the lubricating layer is eliminated by this cleaning process. The cleaning process (S116) may be omitted in a case where the amount of the physical adsorption layer staying after the fixing process (S114a) is smaller than a designated amount and the lubricating layer substantially becomes the chemical adsorption layer.

Thus, the air bearing surface 32a of the rear center rail 32 is surface-roughened and the lubricating layer substantially formed by the chemical adsorption layer is formed on the entire surface of the medium facing surface 18a.

In the lubricating layer forming process, when the lubricating agent is applied, the lubricating agent whose terminal group is not only non-polar but also polar can be used so that there are various choices in selecting the lubricating agent. In addition, the fixing process of the lubricating layer is implemented by applying the lubricating layer to the entire surface of the medium facing surface 18a and therefore the fixing process can be done easily. In addition, in a case where the lubricating agent's terminal group is polar, the fixing process of the lubricating agent can be omitted and therefore the lubricating layer forming process can be simplified.

Next, another example of the head slider forming the magnetic head of this embodiment is discussed.

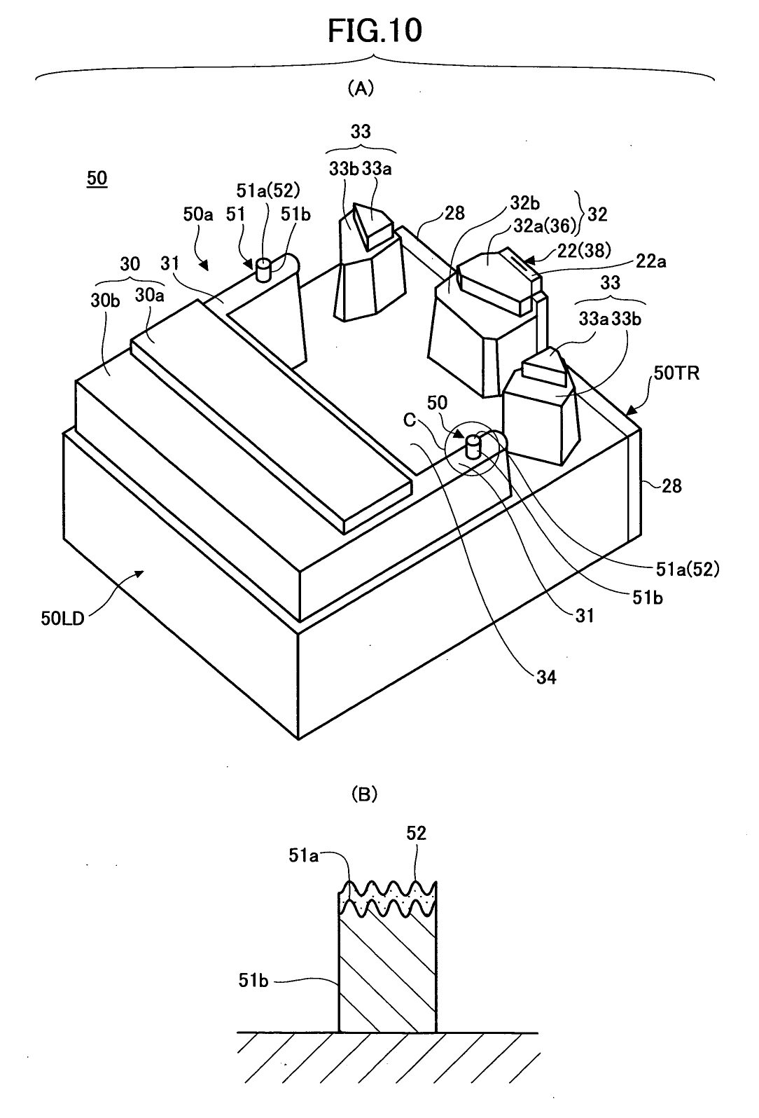

FIG. 10-(A) is a perspective view of another example of the head slider and FIG. 10-(B) is an enlarged cross-sectional view of a C part in FIG. 10-(A). In FIG. 10, parts that are the same as the parts discussed above are given the same reference numerals, and explanation thereof is omitted.

Referring to FIG. 10, a head slider 50 in this example has the same structure as the structure of the head slider shown in FIG. 4 other than an adsorption prevention pad 51 being formed on a top surface of a pair of the slider rails 31 in the medium facing surface 50a of the head slider 50. The adsorption prevention pad 51 includes a body part 51b having a cylindrical-shaped configuration and a head end surface 51a. The head end surface 51a is situated slightly higher than the air bearing surfaces 30a, 32a and 33a. The adsorption prevention pad 51 is, for example, formed by a laminated body wherein a Si film, SiO film and Si film are laminated, in this order, from a side of the top surface of the SiO film or side rail 31. The adsorption pad 51 avoids the air bearing surfaces 30a, 32a and 33a directly coming in contact with the magnetic disk surface in a case where the head slider comes in contact with the magnetic disk at the time of stopping rotation of the magnetic disk, so that it is possible to prevent the medium facing surface 50a from adhering to the magnetic disk.

The head end surface 51a is surface-roughened and the lubricating layer 52 is formed on the head end surface 51a. It is preferable that the average surface roughness of the head end surface 51a be set to be rougher than the element part surface 22a. Furthermore, it is more preferable that the average surface roughness of the head end surface 51a be set in a range from 0.4 nm through 3.0 nm, namely the range the same as the average surface roughness of the air bearing surface 32a. In addition, the lubricating layer 52 is selected from the lubricating agent forming the lubricating layers 36 and 38 shown in FIG. 6-(B) and the film thickness of the lubricating layer 52 is selected in the same range.

Instead of the adsorption pad 51 being arranged at the side of the air flow-out end 50TR of the top surface of the side rail 31 as shown in FIG. 10, the adsorption pad 51 may be arranged close to the side of the air flow-in end 50LD of the top surface of the side rail 31. In addition, the adsorption pads 51 are provided at both ends in the head slider width direction as shown in FIG. 10 so that adsorption can be prevented by a small number of the adsorption pads. Only a single adsorption pad may be at either side in the head slider width direction or three or more adsorption pads 51 may be provided in total.

Such an adsorption prevention pad 51 is formed as follows. It is preferable from the perspective of simplifying the process that the adsorption prevention pad 51 be formed after the surface 45 being the medium facing surface in the step shown in FIG. 9-(A) is flattened and before the surface-roughening process. More specifically, a resist film having an opening part having the same size of the adsorption prevention pad 51 is provided on the surface 45 being the medium facing surface, by using photolithography. Then, a SiO film or Si film, SiO film, and Si film are laminated in order by the spattering method or the CVD method. After that, the resist film and a film laminated on the resist film are eliminated by a lift-off. Thus, the adsorption prevention pad 51 is formed. The surface-roughening process of the head surface 51a of the adsorption prevention pad 51 and the forming process of the lubricating layer 52 are implemented in the same way for the center rail 32 and the air bearing surface 32a.

The lubricating layer 52 is formed at the head end surface 51a of the adsorption prevention pad 51. Hence, the surface free energy of the head slider 50 is reduced so that water or dust may not be adsorbed. In addition, since the head end surface 51a is surface-roughened, even if the head end surface 51a comes close to the magnetic disk surface when the head slider 50 floats, the attraction force working between them may be reduced so that adsorption instability of floating can be avoided. In addition, the head slider 50 has the same effect as the head slider 18 shown in FIG. 4. Next, a detailed example of this embodiment is discussed.

### DETAILED EXAMPLE

A magnetic head including a head slider having a medium facing surface having a size of 1.25 mm (length) and 1.0 mm (width) is used in this example. The head slider has a medium facing surface shown in FIG. 4. The surface-roughening process is implemented to all of the air bearing surfaces 30a, 32a and 33a. The lubricating layer covers the entire surface of the medium facing surface. The average surface roughness and the thickness of the lubricating layer of the air bearing surface of the head slider vary.

As a surface-roughening process, the etching is implemented on the magnetic head by the RIE method using CF₄ gas. Fomblin (trademark) Z25 is used as the lubricating agent and applied by the lifting method. Then, the ultraviolet ray having a wave length of 172 nm is irradiated for 10 seconds in the nitrogen atmosphere by using a UV irradiation apparatus so that the fixing process is implemented. After that, the cleaning process for the medium facing surface is implemented for approximately 2 minutes by using the above-mentioned Vertrel (trademark) XF. Coefficient of friction, take-off amplitude, and touch-down pressure of the magnetic head made by the above-mentioned process are evaluated by using a depression atmosphere head running testing machine. Here, as the coefficient of friction is smaller, the adsorption force between the head slider and the magnetic disk surface is smaller and this is preferable.

The touch-down pressure is a pressure whereby the ambient pressure is gradually reduced while the magnetic disk is rotated at a designated linear speed (20 m/s) so that the head slider and the magnetic disk start coming into contact with each other. The lower the touch-down pressure is, the smaller the floating amount in a state where the magnetic head stably floats and this is preferable.

The take-off pressure is measured and converted to the take-off amplitude. The take-off pressure is a pressure whereby the reduced ambient pressure is gradually increased while the magnetic disk is rotated at a designated linear speed (20 m/s) so that the head slider and the magnetic disk do not come in contact each other. The take-off amplitude shows the take-off pressure by corresponding to the amplitude on the earth on the assumption that an atmospheric pressure at 0 meter above sea level is a pressure of 1 atmosphere. The higher the take-off amplitude is, the smaller the attraction force between the head slider and the magnetic disk surface at the time of floating is and this is preferable.

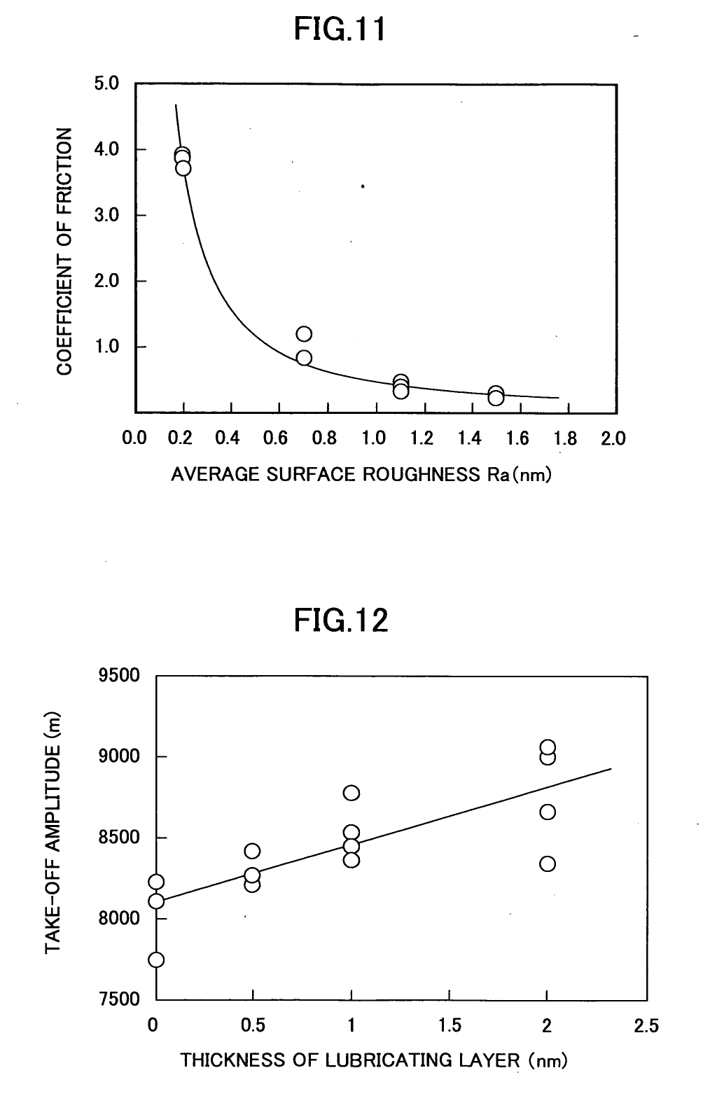

FIG. 11 is a graph showing a relationship between the coefficient of friction and an average surface roughness of an air bearing surface of the embodiment. In the example shown in FIG. 11, the thickness of the lubricating layer is set to be 1.0 nm. For the purpose of comparison, the coefficients of friction of the magnetic heads (the average surface roughness Ra is 0.2 nm) made in the same way other than that the air bearing surface not being surface-roughened are shown in FIG. 11.

Referring to FIG. 11, in cases where surface-roughening is implemented up to a case where Ra is 0.2 nm, that is, in cases where Ra is 0.7 nm, 1.1 nm, and 1.5 nm, the coefficient of friction is approximately 30% and sufficiently reduced. It is also found, through a curve connecting each point in FIG. 11, that the coefficient of friction is sufficiently low if Ra is equal to or larger than 0.4 nm. Hence, it is preferable to set Ra to be larger than 0.4 nm. It is also preferable that the average surface roughness be set equal to or smaller than 3.0 nm at a point where the medium facing surface and the magnetic disk surface come contact each other.

The average surface roughness is measured by AFM (Nano scope, product name) manufactured by Veeco. The contactor whose head has a radius of curvature of 20 nm is used so that an area of 10 μm×10 μm is measured.

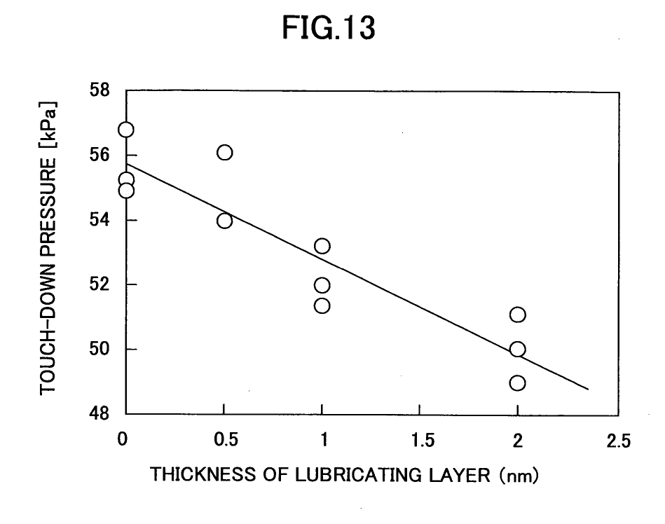

FIG. 12 is a graph showing a relationship between a take-off height and a thickness of a lubricating layer in the embodiment. FIG. 13 is a graph showing a relationship between a touch-down pressure and the thickness of a lubricating layer in the embodiment.

In examples shown in FIG. 12 and FIG. 13, the surface average roughness of the air bearing surface is set to be 0.7 nm. For the purpose of comparison, a magnetic head (the thickness of the lubricating layer is 0) made in the same way other than that the lubricating layer is not formed is shown in FIG. 12 and FIG. 13.

Referring to FIG. 12, as compared with that the thickness of the lubricating layer being 0 nm, the take-off amplitude is increased in cases where the lubricating layer has a thickness of 0.5 nm, 1.0 nm and 2.0 nm. Thus, it is found that the attraction force between the head slider and the magnetic disk surface at the time of floating in cases where the lubricating layer has thicknesses of 0.5 nm through 2.0 nm is smaller than a case where the lubricating layer is not formed.

Referring to FIG. 13, it is found that the touch-down pressure is reduced in cases where the lubricating layer has a thickness of 0.5 nm, 1.0 nm and 2.0 nm as compared with a case where the lubricating layer has a thickness of 0 nm. Thus, it is found that the attraction force between the head slider and the magnetic disk surface at the time of floating in cases where the lubricating layer has a thicknesses of 0.5 nm through 2.0 nm is smaller than a case where the lubricating layer is not formed, so that the floating amount in a state where the magnetic head stably floats is small.

According to the embodiment shown in FIG. 11 through FIG. 13, it is preferable that the average surface roughness of the air bearing surface of the medium facing surface be set to be 0.4 nm through 2.0 nm and the thickness of the lubricating layer be set to be 0.5 nm through 2.0 nm.

The present invention is not limited to these embodiments, but variations and modifications may be made without departing from the scope of the present invention.

For example, the present invention can be applied in a case where the element part of the head slider is formed in the rear side rail instead of the rear center rail. In this case, the air bearing surface of the rear side rail where the element part may be formed is surface-roughened and the lubricating layer may be formed on the roughened air bearing surface and the surface of the element part.

In addition, the present invention is not limited to a complete floating type magnetic head but can be applied to a near contact type or contact type magnetic head.

This patent application is based on Japanese Priority Patent Application No. 2005-105238 filed on Mar. 31, 2005 and the entire contents of which are hereby incorporated by reference.

What is claimed is:

1. A magnetic head, comprising:
a head slider configured to float above a recording medium and having an element part for recording to and reproducing from the recording medium, the element part being situated on a medium facing surface facing to the recording medium;
wherein the medium facing surface has a first air bearing surface situated in a vicinity of a side of an air flow-out end,
the medium facing surface has a rear rail having the element part situated at the side of the air flow-out end of the first air bearing surface, and
the first air bearing surface is covered with a lubricating layer made of water repellent resin and has an average surface roughness larger than an average surface roughness of a surface of the element part.

2. The magnetic head as claimed in claim 1,
wherein the average surface roughness of the first air bearing surface is equal to or larger than 0.4 nm and equal to or smaller than 3.0 nm.

3. The magnetic head as claimed in claim 1,
wherein the medium facing surface further includes an adsorption prevention pad configured to prevent adhesion with the recording medium, and
a surface of the adsorption prevention pad is covered with the lubricating layer.

4. The magnetic head as claimed in claim 3,
wherein an average surface roughness of a surface of the adsorption prevention pad is larger than the average surface roughness of the surface of the element part.

5. The magnetic head as claimed in claim 1, further comprising:
a rear side rail having a second air bearing surface situated at both ends in a width direction in the vicinity of the sides of the air flow-out end of the medium facing surface;
wherein the second air bearing surface is covered with the lubricating layer and has an average surface roughness larger than the average surface roughness of the surface of the element part.

6. The magnetic head as claimed in claim 1,
wherein the medium facing surface has a front rail having a third air bearing surface situated in the vicinity of the side of the air flow-out end of the medium facing surface, and
the third air bearing surface is covered with the lubricating layer made of the water repellent resin and has an average surface roughness larger than the average surface roughness of the surface of the element part.

7. The magnetic head as claimed in claim 1,
wherein the lubricating layer is substantially chemically bonded to a surface which is a foundation of the lubricating layer.

8. The magnetic head as claimed in claim 1,
wherein the lubricating layer includes at least one of fluorine group carbon hydride or fluorine group polyether.

9. The magnetic head as claimed in claim 1,
wherein the lubricating layer has a film thickness of equal to or larger than 0.5 nm and equal to or smaller than 2.0 nm.

10. A manufacturing method of a magnetic head, the magnetic head having a head slider configured to float above a recording medium and having an element part for recording to and reproducing information from the recording medium, the element part being situated on a medium facing surface facing the recording medium, the manufacturing method comprising the steps of:
a) forming the medium facing surface by processing a designated surface of a base part where the element part is formed; and
b) forming a lubricating layer on the medium facing surface;
wherein the step a) includes a process of surface-roughening an area functioning as an air bearing surface, and
the lubricating layer covering at least the area which is a surface-roughened air bearing surface is formed in the step b).

11. The manufacturing method of the magnetic head as claimed in claim 10,
wherein the process of surface-roughening is implemented by a spatter etching method or a reactive ion etching method.

12. The manufacturing method of the magnetic head as claimed in claim 10,
wherein the step a) includes a process of surface roughening a first air bearing surface formed in a vicinity of a side of an air flow-out end of the medium facing surface, and
the lubricating layer covering the first air bearing surface and a surface of the element part is formed in the step b).

13. The manufacturing method of the magnetic head as claimed in claim 12,
wherein the step b) includes the steps of:
b1) applying a lubricating agent made of a lubricating agent molecule whose terminal group is non-polar so that a substantially entire surface of the medium facing surface is covered;
b2) irradiating a high energy ray or beam on the lubricating layer formed on the first air bearing surface of the medium facing surface and the surface of the element part; and
b3) cleaning the medium facing surface by using a solvent wherein the lubricating agent is soluble.

14. The manufacturing method of the magnetic head as claimed in claim 13,
wherein the high energy ray or beam is a ray or beam selected from the group consisting of ultraviolet rays, X rays, an electronic beam, and a focused ion beam.

15. The manufacturing method of the magnetic head as claimed in claim 10,
wherein the step a) further includes a step of forming an adsorption prevention pad which prevents an adhesion with the recording medium, and
the lubricating layer is simultaneously formed on a surface of the adsorption prevention pad in the step b).

16. The manufacturing method of the magnetic head as claimed in claim 15,
wherein the surface of the adsorption prevention pad is surface-roughened after the adsorption prevention pad is formed.
